(19) United States
(12) Patent Application Publication
(10) Pub. No.: US 2006/0109393 A1
(43) Pub. Date: May 25, 2006

(54) Liquid crystal display, backlight unit and frame structure thereof

(75) Inventors: Pin-Hung Hsu, Tainan Science Based Industrial Park (TW); I-Lung Yang, Tainan Science Based Industrial Park (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: CHI MEI OPTOELECTRONICS CORP., Tainan Science Based Industrial Park (TW)

(21) Appl. No.: 11/217,457

(22) Filed: Sep. 2, 2005

(30) Foreign Application Priority Data
Nov. 23, 2004 (TW) 93136062

(51) Int. Cl. G02F 1/1333

(52) U.S. Cl. 349/58

(57) ABSTRACT

A frame structure of a backlight unit (BLU) of a liquid crystal display (LCD) includes an outside frame and an inside housing. The outside frame has an aperture. The inside housing has a bump for carrying an object. The bump is projected from the edge of the inside housing and corresponds to the aperture. The inside housing is disposed in the outside frame. The bump penetrates through the aperture to be projected from the outside frame so that the inside housing is buckled into the outside frame.

This application claims the benefit of Taiwan Application Serial No. 093136062, filed Nov. 13, 2001, which is incorporated herein by reference in its entirety.

### BACKGROUND

The invention relates in general to a frame structure, and more particularly to a frame structure of the liquid crystal display and the backlight unit, which is capable of carrying an object.

Thin film transistor planar displays in general, and thin film transistor liquid crystal displays (TFT-LCD) in particular, mainly use thin film transistors arranged in matrix and appropriate electronic components, such as capacitors and adaptors, for controllably varying the orientation of liquid crystal molecules, so that rich colored pictures can be produced. TFT-LCDs have numerous advantages, such as thin configuration, low power-consumption and low radiation, over the conventional displays, such as cathode ray tube (CRT) displays. As a result, TFT-LCDs are now widely used both for applications of portable electronic products, such as notebooks and personal digital assistants (PDA), as well as desktop computers.

A conventional liquid crystal display comprises a metal frame, a display unit and a backlight unit (Backlight Unit, BLU). The display unit comprises a display panel, a circuit board capable of processing data signals, and tape carrier packages (TCPs) connected between the display panel and the circuit board. The backlight unit, driven by an inverter, is positioned under the display unit to provide an even illumination of light to the display unit.

Besides, the conventional liquid crystal display further comprises a bracket for supporting and fixing the inverter for driving the backlight unit. The conventional bracket is normally soldered or adhered to the metal frame.

However, the metal frame might be deformed when the bracket is soldered thereto, whereas, when the bracket is adhered to the frame by an adhesive, the connection between the components might fail if the adhesive used lacks sufficient strength to support the inverter. Besides, the metal frame is usually made of aluminum to reduce the weight of the liquid crystal display. However, it is difficult to solder an iron bracket to a frame made of aluminum.

### SUMMARY

The embodiments of the invention provide a frame structure, a backlight unit, and a liquid crystal display.

A frame structure in accordance with an embodiment comprises an outside frame having an aperture, and an inside housing having a bump for carrying an object. The bump is projected from the edge of the inside housing and corresponds to the aperture. The inside housing is disposed in the outside frame. The bump penetrates through the aperture to be projected from the outside frame and the inside housing is whereby buckled into outside frame.

A backlight unit (BLU) in accordance with an embodiment is disposed in an outside frame of an electronic component. The backlight unit includes an illuminating component for providing a light source and an inside housing accommodating the illuminating component. One side of the inside housing has a bump for carrying an object. The bump is projected from the edge of the inside housing and corresponds to an aperture of the outside frame. The inside housing is disposed in the outside frame. The bump penetrates through the aperture to be projected from the outside frame and the inside housing is whereby buckled into the outside frame.

A liquid crystal display (LCD) in accordance with an embodiment comprises an outside frame having an aperture, a display unit having a display panel and positioned in the outside frame, a backlight unit disposed in the outside frame and in the rear side of the display unit to provide a backlight source to the display panel. The backlight unit includes an illuminating component for providing the backlight source and an inside housing accommodating the illuminating component. One side of the inside housing has a bump for carrying an object. The bump is projected from the edge of the inside housing and corresponds to the aperture of the outside frame. The inside housing is disposed in the outside frame. The bump penetrates through the aperture to be projected from the outside frame and the inside housing is whereby buckled into the outside frame.

Other objects, features, and advantages of the invention will become apparent from the following detailed description of the preferred but non-limiting embodiments. The following description is made with reference to the accompanying drawings. Anyone who is skilled in related technology would be able to understand and implement the technology accordingly.

### BRIEF DESCRIPTION OF THE DRAWINGS

The embodiments of the present invention are illustrated by way of example, and not by limitation, in the figures of the accompanying drawings, wherein elements having the same reference numeral designations represent like elements throughout, wherein:

FIG. 1 is an exploded, perspective view of a liquid crystal display according to an embodiment of the invention; and

FIG. 2 is a perspective view of the liquid crystal display in the assembled state.

### DETAILED DESCRIPTION OF THE EMBODIMENTS

Before the embodiments of the invention are explained in detail, it is to be understood that the invention is not limited in its application to the details of construction and the arrangements of components set forth in the following description or illustrated in the drawings. The invention is capable of other embodiments and of being practiced or being carried out in various ways. Also, it is understood that the phraseology and terminology used herein are for the purpose of description and should not be regarded as limiting. The use of letters to identify steps of a method or process is simply for identification and is not meant to indicate that the steps should be performed in a particular order.

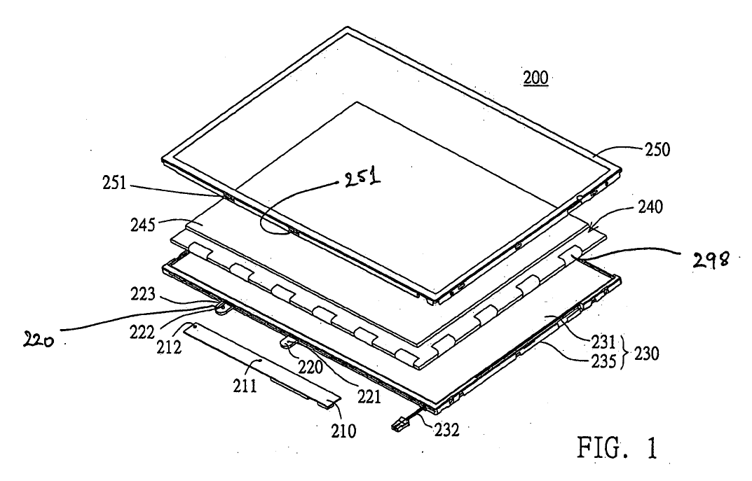

FIG. 1 is an exploded, perspective view of a liquid crystal display 200 according to an embodiment of the invention. The liquid crystal display 200 includes an outside frame 250, a display unit 240, and a backlight unit 230. The display unit 240 includes a display panel 245, a circuit board (not shown) capable of processing data signals, and tape carrier packages (TCPs) 298 for connecting the display panel 245 and the circuir board. The display panel 245 is disposed in the outside frame 250 which can be a metal frame. One side of the outside frame 250 has an aperture 251. The backlight unit 230 is positioned under the display unit 240 to provide an uniform light source to the display unit 240.

As shown in FIG. 1, the backlight unit 230 includes an illuminating component 231 and an inside housing 235. The illuminating component 231 includes one or more optical sheets, a light guide plate, a reflecting plate and a lamp, for example, a cold cathode fluorescent lamp or LEDs. A more detailed description of the illuminating component for a backlight unit is provided in Taiwan Application Serial No. 093137678, filed Dec. 6, 2004, which is incorporated herein by reference in its entirety. In particular, the lamp (not shown) is positioned adjacent the light guide plate (not shown) to define together with the light guide plate a light source. A lamp cover (not shown) is used to protect the lamp. The lamp is fixed by a lamp holder (not shown). A lamp wire 232 is extended from the lamp holder to be electrically connected with an inverter 210 through a connector (not shown). In an embodiment when the lamp is a fluorescent lamp, an inert gas is filled in the lamp, and a fluorescent agent is pasted on the inner wall of the lamp. When an external voltage is applied to the electrodes positioned at the two ends of the lamp, the electrons released from the electrodes collide with and excite atoms of the inert gas, such as Xenon, so that ultraviolet (UV) rays are emitted from the excited inert gas. When the UV rays impinge upon the fluorescent agent pasted on the inner wall of the lamp, the UV rays are converted to visible light which further impinges upon the light guide plate. The light guide plate is used to change the path of the light. Therefore, the light emitted from the lamp is guided to reach the display panel via the light guide plate. The size of the light guide plate is the same as that of the display panel and is essential to the size and weight of the liquid crystal display 200. The commonly used materials for the light guide plate include polymethyl methacrylate (PMMA), cycloolefin polymer (COP) and so forth. One or more optical sheets are disposed atop of the light guide plate for further light manipulation, such as focusing, diffusing, attenuating or uniformizing the light. The optical sheet(s) in an embodiment include(s) a diffusion sheet. The backlight unit 230 in an embodiment has three optical sheets. The backlight unit 230 in an embodiment further has a reflective film attached onto the reflecting plate positioned under the light guide plate to reflect the light rays which would otherwise be leaked from the light guide plate, so that the light reflection efficiency is improved. The backlight unit 230 is disposed in the outside frame 250 but positioned in the rear side of the display unit 240 to provide a backlight source for display panel 245. The illuminating component 231 provides such a light source. The inside housing 235 accommodates the illuminating component 231. One side of the inside housing 235 has at least a bump 220. The bump 220 is projected from the edge of the inside housing 235 and corresponds to the aperture 251. The inside housing 235 is disposed in the outside frame 250. The bump 220 penetrates through the corresponding aperture 251 to be projected from the outside frame 250, so that the inside housing 235 is buckled into outside frame 250 and the inverter 210 can be fixed on the bump 220.

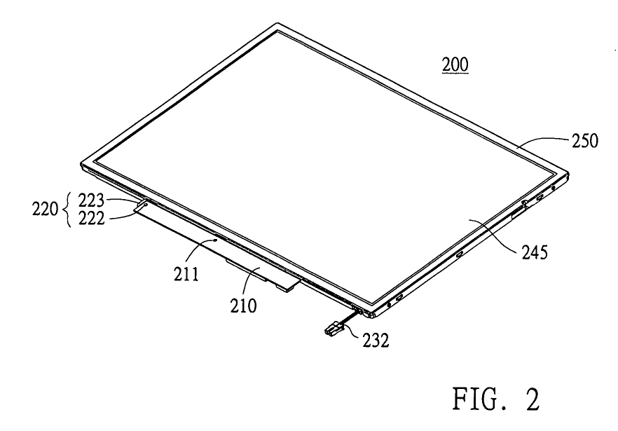

FIG. 2 is a perspective view of the liquid crystal display 200 in the assembled state. The inverter 210 can be fixed to the bump 220 in a number of ways. An example is illustrated in FIG. 1 and FIG. 2. In particular, the liquid crystal display 200 further includes a fastener (not shown) such as a screw or a pin. The bump 220 has a hole 221, and the inverter 210 has a matching hole 211. The screw or the pin penetrates through the holes 221 and 211, which have been aligned, to fix the inverter 210 to the bump 220. In an embodiment, at least one bump 220 of the liquid crystal display 200 further includes a positioning piece 222 which can be configured as a pin like projection, and a positioning stopper 223 which can be configured as a raised edge or portion on the bum 220. The inverter 210 further includes a hole 212 corresponding to the positioning piece 222. One side of the inverter 210 adjacent the hole 212 is placed tightly against the positioning stopper 223. The positioning piece 222 penetrates through the aperture 212 to position the inverter 210 on the bump 220.

In an embodiment of the liquid crystal display 200, the inside housing 235 is a plastic housing, and is preferably formed in one piece with the bump 220. Thus, the bump can be simultaneously formed on the inside housing 235 by plastic injection molding. In such a manufacturing process, not only the manufacture complexity is reduced but the cost is also lowered. Besides, the formed-in-one-piece structure enhances the strength of the bump to be capable of carrying a heavier object than the conventional structure.

In the backlight unit of the liquid crystal display disclosed in the above embodiments of the invention, the bump disposed on the frame structure and the plastic inside housing are formed in one piece. Compared with the conventional method of soldering an iron piece on the metal frame, the embodiments of the invention eliminate the need for iron pieces, thus saving material and labor costs associated with such iron pieces. The backlight unit of the liquid crystal display according to the embodiments the invention also has a lower manufacturing cost and a higher supporting strength than the conventional structures. Besides, the bump disposed on the plastic housing in accordance with the embodiments of the present invention can be used in liquid crystal display having metal frames made of aluminum, so as to reduce the weight of the displays.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A frame structure for a display, said frame structure comprising:
an outside frame having at least an aperture; and
an inside housing having at least a bump for carrying an object, the bump projected from an edge of the inside housing and corresponding to the aperture; wherein the inside housing is disposed in the outside frame, the bump penetrates through the aperture to be projected from the outside frame, and the inside housing is whereby buckled into the outside frame.

2. The frame structure according to claim 1, wherein the bump is adapted to support thereon on an inverter.

3. The frame structure according to claim 2, wherein each of the bump and the inverter respectively has a hole, and the structure further comprises a fastener penetrating through the holes to fix the inverter to the bump.

4. The frame structure according to claim 3, wherein the fastener is a screw or a pin.

5. The frame structure according to claim 3, wherein the inverter has another hole, and the inside housing further comprises another bump having a positioning piece and a positioning stopper, the positioning piece penetrating through said another hole of the inverter, which is placed against the positioning stopper, to fix the inverter to said another bump.

6. The frame structure according to claim 2, wherein the inverter has a hole, and the bump comprises a positioning piece and a positioning stopper, the positioning piece penetrating through the hole of the inverter, which is placed against the positioning stopper, to fix the inverter to the bump.

7. The frame structure according to claim 1, wherein the inside housing is a plastic housing.

8. The frame structure according to claim 1, wherein the bump and the inside housing are formed in one piece.

9. The frame structure according to claim 1, wherein the outside frame is a metal frame.

10. A backlight unit (BLU) to be disposed in an outside frame of an electronic component, the backlight unit comprising:
an illuminating component for providing a light source; and
an inside housing accommodating the illuminating component, the inside housing having a bump for carrying an object, the bump projected from an edge of the inside housing and corresponding to an aperture of the outside frame;
wherein the inside housing is disposed in the outside frame, the bump penetrates through the aperture to be projected from the outside frame, and the inside housing is whereby buckled into the outside frame.

11. The backlight unit according to claim 10, further comprising an inverter carried by said bump.

12. The backlight unit according to claim 11, wherein each of the bump and the inverter respectively has a hole, and the backlight unit further comprises a fastener penetrating through the holes to fix the inverter to the bump.

13. The backlight unit according to claim 12, wherein the fastener is a screw or a pin.

14. The backlight unit according to claim 12, wherein the inverter has another hole, and the inside housing further comprises another bump having a positioning piece and a positioning stopper, the positioning piece penetrating through said another hole of the inverter, which is placed against the positioning stopper, to fix the inverter to said another bump.

15. The backlight unit according to claim 10, wherein the inverter has a hole, and the bump comprises a positioning piece and a positioning stopper, the positioning piece penetrating through the hole of the inverter, which is placed against the positioning stopper, to fix the inverter to the bump.

16. The backlight unit according to claim 10, wherein the inside housing is a plastic housing.

17. The backlight unit according to claim 10, wherein the bump and the inside housing are formed in one piece.

18. The backlight unit according to claim 10, wherein the outside frame is a metal frame.

19. A liquid crystal display (LCD), comprising:
an outside frame having an aperture;
a display unit positioned in the outside frame, wherein the display unit has a display panel; and
a backlight unit disposed in the outside frame and in the rear side of the display unit to provide a backlight source to the display panel, the backlight unit comprising:
an illuminating component for providing the backlight source; and
an inside housing accommodating the illuminating component, the inside housing having a bump for carrying an object, the bump projected from an edge of the inside housing and corresponding to the aperture of the outside frame;
wherein the inside housing is disposed in the outside frame, the bump penetrates through the aperture to be projected from the outside frame, and the inside housing is whereby buckled into the outside frame.

20. The liquid crystal display according to claim 19, further comprising an inverter carried by said bump.

21. The liquid crystal display according to claim 20, wherein each of the bump and the inverter respectively has a hole, and the LCD further comprises a fastener penetrating through the holes to fix the inverter to the bump.

22. The liquid crystal display according to claim 21, wherein the fastener is a screw or a pin.

23. The liquid crystal display according to claim 21, wherein the inverter has another hole, and the inside housing further comprises another bump having a positioning piece and a positioning stopper, the positioning piece penetrating through said another hole of the inverter, which is placed against the positioning stopper, to fix the inverter to said another bump.

24. The liquid crystal display according to claim 19, wherein the inverter has a hole, and the bump comprises a positioning piece and a positioning stopper, the positioning piece penetrating through the hole of the inverter, which is placed against the positioning stopper, to fix the inverter to the bump.

25. The liquid crystal display according to claim 19, wherein the inside housing is a plastic housing.

26. The liquid crystal display according to claim 19, wherein the bump and the inside housing are formed in one piece.

27. The liquid crystal display according to claim 19, wherein the outside frame is a metal frame.
